(19) United States
(12) Patent Application Publication
(10) Pub. No.: US 2012/0109623 A1
(43) Pub. Date: May 3, 2012

(54) Stimulus Description Collections

(75) Inventors: William B. Dolan, Kirkland, WA (US); David L. Chen, Austin, TX (US)

(73) Assignee: Microsoft Corporation, Redmond, WA (US)

(21) Appl. No.: 12/916,951

(22) Filed: Nov. 1, 2010

(51) Int. Cl. G06F 17/28

(52) U.S. Cl. 704/2

(57) ABSTRACT

The subject disclosure generally describes a technology by which text and/or speech descriptions are collected by showing a stimulus such as video clips to contributors (e.g., of a crowd-sourcing service). The descriptions, which are in the language of each contributor's choice, are of the same stimulus and thus associated with one another. While each contributor may be monolingual, the technique allows for the collection of approximately bilingual data, since more than one language may be represented among the different contributors. The descriptions may be used as translation data for training a machine translation engine, and as paraphrase data (grouped by the same language) for training a machine paraphrasing system. Also described is evaluating the quality of a machine paraphrasing system via a distinctiveness metric.

### BACKGROUND

Building a useful machine translation system requires a lot of data. In particular, the data cannot simply be the translation of the words in one language to those in another language, but rather needs to include phrases and sentences so that the context of multiple words is considered. While there are some sources of translated data available, such as the same web page content translated into different languages, and governmental documents (e.g., the European Union translates documents into multiple languages), there are drawbacks with using these sources.

While a great deal of parallel text exists in digital form (web data, scanned books, and so forth), the nature of this data is skewed in various ways. For instance, certain domains (e.g. government, science) tend to be very well-represented, while others (e.g., entertainment, sports) are much less well-covered. Even more significant is the skewing for particular language pairs; e.g., while there is a substantial amount of English-Spanish data available in digital form, there is very little Hungarian-Spanish or Vietnamese-Spanish. When parallel speech data is considered, the problem is even greater. Relatively little spoken parallel speech data exists, and collecting it can be extremely expensive because of the laborious nature of speech transcription.

Attempts have been made to use bilingual speakers to translate sentences and phrases from one language to another. However, employing such bilingual speakers is generally costly, and thus only a limited amount of data can be practically collected in this way. Gathering translation data from bilingual speakers within the general public (“crowd-sourcing”) could in principle help collect large amounts of parallel data, but this approach is also problematic. For one, translation quality can vary greatly from speaker to speaker, and motivating highly skilled bilingual contributors can be difficult. If translators are offered significant financial rewards for contributing data, cheating can become a problem, e.g., unscrupulous programmers can write automated “bots” that simply call an existing machine translation engine to supply a translation.

Paraphrase data refers to different sentences and phrases that mean approximately the same thing in a given language. This is generally similar to translation data except that only monolingual annotators are needed to produce paraphrase data. However, collecting paraphrase data has its own problems, including that the annotator paraphrasing a source sentence or phrase into target data is biased by the source sentence/phrase. For example, many people tend to simply substitute each source noun with a different target noun and/or each source verb for a different target verb, similar to using a thesaurus. Other people find it difficult to construct paraphrases in general, e.g., they are confused as to whether they are supposed to reorder the words, substitute words and/or do something else with the source text to provide the target text. As with translation data, the paucity of paraphrase data is even more extreme with respect to spoken language. There is virtually no spoken paraphrase data that might be used to train models aimed at understanding spoken monolingual utterances.

In sum, existing techniques for collecting translation or paraphrase data have a number of drawbacks that adversely impact how much data can be collected, as well as the quality of the data. Notwithstanding, it is desirable to have large amounts of good quality translation and/or paraphrase data for building machine-based systems.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which translation and paraphrase data are collected by showing a stimulus to contributors, such as video clips to viewers (e.g., of a crowd-sourcing service), who then respond with linguistic (text and/or speech) descriptions of that stimulus in a language of their choice. Data contributors may be entirely monolingual, and each piece of collected data is a description of the same stimulus and is thus associated with each other piece. The collected data includes translation data that relates the descriptions in various languages to one another, and paraphrase data that relates the descriptions in the same language to one another in that language. Although these descriptions are not exactly “parallel” in the linguistic sense, they are parallel in a more abstract semantic sense, because they describe the same scene and action in one or more languages.

Paired descriptions corresponding to different languages in the translation data may be used as a basis for translation training data provided to train a machine translation system. Descriptions in the paraphrase data may be used as a basis for paraphrase training data provided to a machine paraphrasing system.

In one aspect, there is provided a mechanism for evaluating the quality of a machine paraphrasing system. This includes a metric for measuring the distinctiveness of a machine-generated paraphrased sentence or phrase with respect to the original sentence or phrase. Another metric may measure how well the machine-generated paraphrased sentence or phrase retains the original sentence's or phrase's meaning, and these metrics may be combined to determine the quality of the machine output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for collecting descriptions of the same stimulus, comprising a video clip, from various contributing describers for maintaining as translation data and paraphrase data.

FIG. 2 is representation of using collected translation data to train a machine translation system.

FIG. 3 is representation of using collected paraphrase data to train a machine paraphrasing system, as well as a mechanism for evaluating the quality of a machine paraphrasing system.

FIG. 4 shows an illustrative example of a computing environment into which various aspects of the present invention may be incorporated.

### DETAILED DESCRIPTION

Various aspects of the technology described herein are generally directed towards collecting translation data without bilingual speakers, as well as collecting natural paraphrase data without presenting the annotator with a source sentence or phrase to paraphrase. To this end, a large number of contributors are shown a selected stimulus (e.g., a video clip, a still image or another stimulus) that is generally intended to elicit universal responses from among the contributors. The contributors are asked to describe the stimulus, e.g., the main action or event that occurred in the video, in the language of their choosing, with the descriptions (text and/or speech) saved for each stimulus. This set of contributors may span a broad range, such as contributors from all over the world. As such, translation data that describes the same event/stimulus in various languages is obtained, as well as paraphrase data that describes the same event/stimulus in the same language.

It should be understood that any of the examples herein are non-limiting. For one, many of the examples herein describe a stimulus in the form of a brief video clip shown to contributors who are viewers of that clip. However, any suitable stimulus that results in returned translation and/or paraphrase data may be employed, such as one or more still photographs, audio (e.g., a “woman humming,” a “dog barking” and so forth), scent, temperature and/or texture. Another type of stimulus comprises an action carried out by a program, such as to have contributors narrate some programmatic behavior, e.g., making someone's eyes bigger in an application for editing photographs, and then using that data to produce a command-and-control interface; program developers may narrate code snippets to learn code/intent mappings. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing in general.

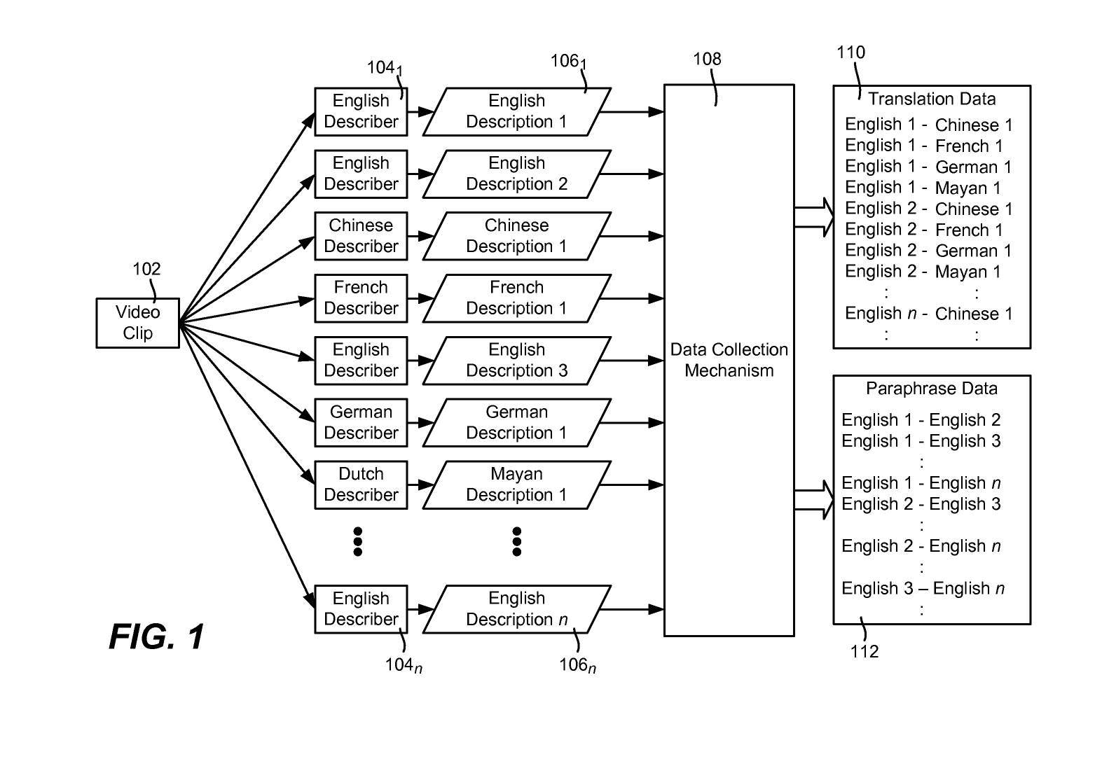

FIG. 1 is a block diagram representing various aspects of the data collection process. A stimulus, which in this example is a video clip 102, such as from an online streaming video source, is shown to a plurality of contributors (“describers”) 104₁-104ₙ who use various languages. Crowd-sourcing, including for payment or other compensation such as points to video game players, is one source of such describers, however other recruiting methods can be envisioned. For example, users of Microsoft® Office Communicator and/or Xbox Live® gamers may be crowd-sourcing contributors that provide help in collecting data, including without necessarily needing compensation.

Each describer 104₁-104ₙ outputs a description 106₁-106ₙ comprising text and/or speech as to what the video clip 102 conveyed to that describer. Each describer 104₁-104ₙ provides the description 106₁-106ₙ in a language of his or her choosing, which the describer may designate, or may be automatically detected.

As exemplified in FIG. 1, a data collection mechanism 108 sorts the descriptions by the various languages and aligns different descriptions with one another by language for the describers of different languages, and by different describers of the same language. The result is translation data 110 and paraphrase data 112. To this end, descriptions of the same videos (or other stimulus) are treated as approximate translations of each other if they are in different languages, and as approximate paraphrases of each other if they are in the same language.

Note that for simplicity, FIG. 1 shows only translation data of English to other languages in the translation data 110, however it is understood that any available pairing of language data may be provided in this way, e.g., Chinese to Mayan. Similarly, only English-to-English paraphrase data are shown in the paraphrase data 112, however any language for which there is more than one description may have paraphrase data generated for that language, e.g., there may be multiple German descriptions of the same stimulus, in which event German-to-German paraphrase data are also available.

By way of example of a very small sample, consider showing a group of describers a brief video clip of a man eating spaghetti. The following English-language descriptions may be collected for the same video-clip, each of which are paraphrases of one another (allowing for identical “paraphrases” to exist):

A man eats spaghetti sauce.
A man is eating food.
A man is eating from a plate.
A man is eating something.
A man is eating spaghetti from a large bowl while standing.
A man is eating spaghetti out of a large bowl.
A man is eating spaghetti.
A man is eating spaghetti.
A man is eating.
A man is eating.
A man is eating.
A man tasting some food in the kitchen is expressing his satisfaction.
The man ate some pasta from a bowl.
The man is eating.
The man tried his pasta and sauce.

The following foreign language data may be collected from the same video clip:

| | |
|---|---|
| German | Ein Mann isst Spagetti. |
| Romanian | Un barbat mananca paste. |
| | Un barbat mananca spaghetti. |
| | Un bucatar mananca ce a preparat. |
| French | Un homme mange des pates. |
| Spanish | Un gordo saborea un plato de pasta. |

Thus, in this simplified example there are five languages for which translation data is available, and two languages (English and Romanian) for which paraphrase data is available. Any two (or possibly more than two) different language sentences may be paired for use in training a machine translation engine, and any two (or more) same language sentences may be paired for use in training a machine paraphrasing system. Note that identical “paraphrase” sentences can be valuable in training, reinforcing the probability of specific word/phrase mappings associated with the “centroid” utterance for a cluster.

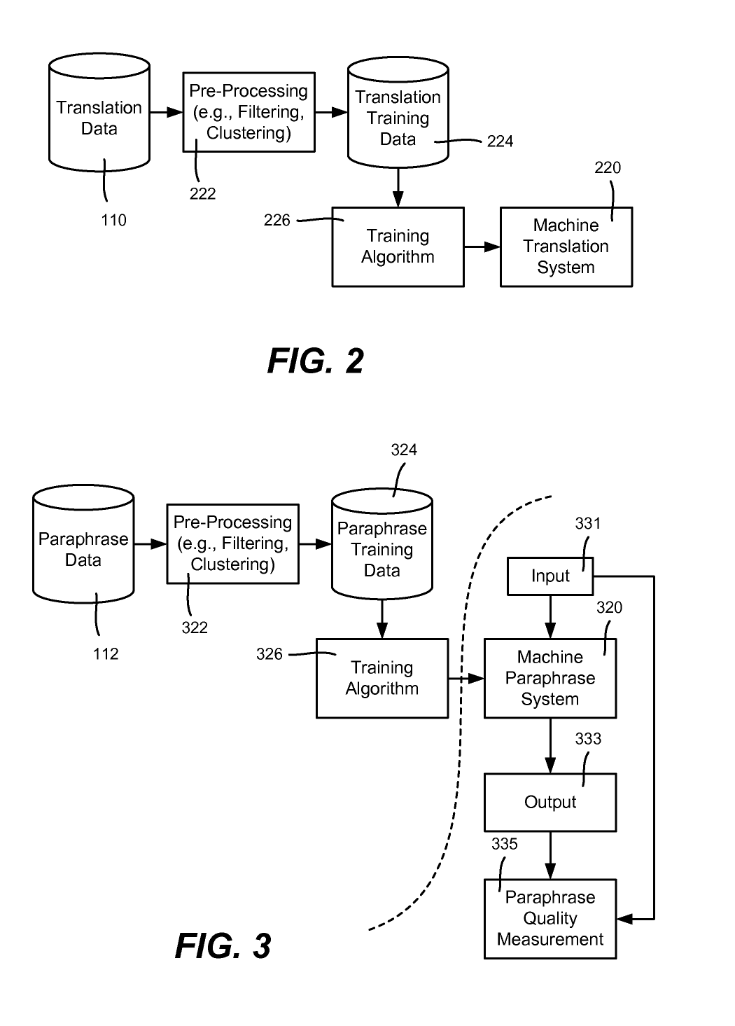

As can be readily appreciated, scaling a video or other stimulus to many thousands of users will result in a significant amount of translation data 110 and paraphrase data 112. As represented in FIGS. 2 and 3, this data 110 and 112 may be used as a basis for training a machine translation system 220 or machine paraphrase system 320, respectively. Rather than applying the data 110 and 112 directly, some pre-processing 222 and 322 may be performed on the data so as to apply better quality data 224 and 324 to the training algorithms 236 and 326, respectively. For example, filtering may be performed after (and/or during) collection to remove intentionally bad translations or paraphrases, such as those containing vulgar language. Clustering (e.g., n-gram based) may be performed to remove outlier sentences or phrases that are likely unreasonable or nonsensical descriptions. Further, If enough sentences or phrases are similar, typographical errors and misspellings in otherwise phrases or sentences can be corrected. For example, spaghetti is easily misspelled, but if “spaghetti” spelled correctly occurs enough times in the data, misspellings may be corrected in other descriptions, such as by building a small custom spell checking dictionary of frequently appearing words that may be used to correct any such misspellings.

Other data may be used to vet the collected data; for example, another set of computer users may be paid to review subsets of the available descriptions and indicate which one or ones they think are the outliers, e.g., pick the worst three descriptions out of ten shown. Such vetting data may be used to home in on the outliers.

Note that while only one video clip has been described thus far as an example stimulus, it is understood that a describer may view and describe many hundreds or thousands of different clips. For each clip, the description data is collected and associated with the descriptions of other viewers of that same clip. The descriptions may be text or speech, or both, improving the quality of text-to-text, text-to-speech, speech-to-speech and speech-to-text translation across languages, as well as paraphrasing in the same language.

Moreover, the clips or other stimulus instances that are presented may be tailored to a specific class of activity or the like for which translation/paraphrase models are of value. By way of example, consider a video game running on a gaming console that allows players to communicate with one another as they play. A combat-style game may have only so many operations that a user can command, but many users may verbally express the command in different ways, e.g., “attack the building” or “charge the enemy compound” may represent the same command. Collecting speech data from game players and associating that data with the actions that occurred allow training a game (or future versions of that game) to provide spoken command-and-control operation, including with paraphrases, instead of only allowing a limited set of commands that need to be explicitly spoken to be recognized.

Note that in addition to command-and-control, machine paraphrasing systems may be used in other applications. These include question answering, search help, providing writing assistance, and so forth, and thus a well-trained machine paraphrasing system is desirable.

Another use of paraphrase data is in translation, such as when there are relatively few descriptions in one language, yet many descriptions (and thus abundant paraphrase data) in another language with which translation is desired. Consider for example that there are thousands of English language descriptions for a video, and only a few in a language such as Tamil. Each source sentence in Tamil may be paired with one target sentence in English, or some number of them, (e.g., five, ten), or all of them. The large number of variations in English may help expand the Tamil dataset; e.g., “man” and “guy” in the English descriptions may map well to the same one word in Tamil. Indeed, tests proved that in general, the more targets to which such a source is mapped, the better the improvement in translation.

In this manner, video data or other stimulus is used to create translation and/or paraphrase data. Note that unlike prior solutions, there is no need to start with a specific linguistic utterance, which inevitably biases the lexical and syntactic choices a contributor might make. With videos or other Internet-provided stimulus, such as from an online video streaming site as the source, and with an online crowd-sourcing service, such as one that pays participants for input, useful data in large amounts may be collected.

Moreover, the selection of stimulus used for data collection is a task that can be delegated to the crowd. For example, the online crowd-sourcing service may gather suitable video segments that clearly show an unambiguous action or event. Such videos are usually five to ten seconds in length, and no more than a minute. After (e.g., manually) filtering them for inappropriate content or otherwise unsuitable videos, the videos are presented to a group of users, such as others in the online crowd-sourcing service.

Still further, users' actions with respect to a stimulus may help determine which ones others receive. For example, if users tend to skip over certain videos or still images, such as if they are confusing or too long, those may be removed and replaced with others, and so on.

Turning to another aspect, while machine translation has a well-known automated metric, BLEU, for evaluating the quality of a machine translation system, heretofore there has been no well-accepted metric for evaluating the quality of a machine paraphrasing system. Note that while the below examples generally refer to the paraphrase of a sentence, it is understood that this includes any part of a sentence that may be paraphrased, including a phrase, or even a longer set of words, such as a paragraph.

In generating a good paraphrase, the paraphrase needs to retain the meaning of the original input sentence. A measure based upon the BLEU-like n-gram overlap metric may be used as a score to measure the success of retaining the meaning of the original sentence, that is, how well a candidate paraphrase remains focused on the correct topic as well as remains fluent.

Further, a general observation is that a paraphrase is most likely more valuable if the paraphrase is as different as possible from the original sentence, (while retaining the meaning of the original sentence). For example, “a man is laughing” may be paraphrased as “a guy is laughing” or as “a man finds something to be very funny.” The simple substitution of “guy” for “man” in the former phrase is not particularly valuable in most scenarios, however the latter phrase is helpful. For example, the latter phrase may be used to suggest an alternative way that a writer may better convey his or her idea when writing something.

Described herein is a scoring metric that measures n-gram dissimilarity for evaluating differences between paraphrases of sentences. In one implementation, the number of n-grams (up to n=4 by default) that do not appear in the original sentence is counted in the paraphrase candidate. This count is divided by the total number of n-grams in the paraphrase candidate. The scores for n=1, 2, 3, 4 may be averaged to compute an overall distinctiveness score. As can be readily appreciated, other dissimilarity scores based upon n-grams or the like are feasible and may be alternatively or additionally employed.

FIG. 3 shows an example of how paraphrase quality may be evaluated by such a metric. Input data 331 such as a sentence is fed to the trained machine paraphrase system 320, which generates the related paraphrased output data 333. The input data 331 and output data 333 may be fed to a paraphrase quality measurement component 335, which comprises algorithms for computing the above-described metrics, for example. Note that the comparison results may be used in any suitable way, e.g., fed back to adjust the training algorithm 326, for example, or used internally in a paraphrasing system to select among candidates to output. Note that the paraphrase quality measurement component 335 may be used with other machine paraphrasing systems, including those not necessarily trained on stimulus description collections; the dashed line in FIG. 3 exemplifies that the training aspects and quality measurement aspects (as well as other aspects such as online usage) may be independent from one another.

The use of descriptions from the same stimulus enables collecting arbitrarily many naturally-occurring descriptions of the same event/stimulus, whereby a good range of possible linguistic descriptions of that event/stimulus is obtained. This gives the metric enough to work with in deciding whether a machine-generated paraphrase of some input string retains the original meaning, yet deviates enough so as to provide value.

In one implementation, the BLEU-like n-gram overlap score and the dissimilarity metric may be mathematically combined to find the paraphrase that retains the meaning of the original sentence, yet is most dissimilar. For example, the BLEU-like n-gram overlap score may act as a constraint, such that the selected paraphrase is the one that is maximally distinct within a meaning/fluency range appropriately permitted by the constraint.

### Exemplary Operating Environment

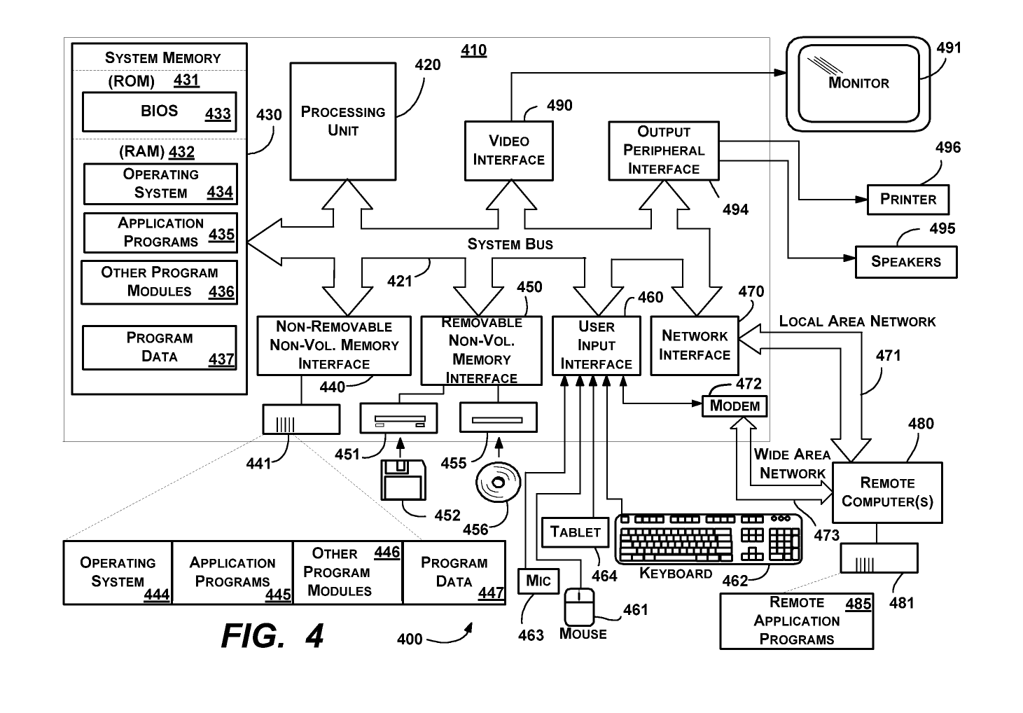

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor, comprising, presenting a stimulus to contributors, collecting a linguistic description from each responding contributor as to what the stimulus represented to the contributor, and maintaining at least some of the linguistic descriptions corresponding to that stimulus in association with one another as translation data for use in training a translation engine, or as paraphrase data for use in training a paraphrasing system, or both as translation data for use in training a translation engine, and as paraphrase data for use in training a paraphrasing system.

2. The method of claim 1 wherein collecting the linguistic description comprises receiving text data.

3. The method of claim 1 wherein collecting the linguistic description comprises receiving speech data.

4. The method of claim 1 wherein maintaining the linguistic descriptions in association with one another comprises pairing at least one of the linguistic descriptions in one language with at least one of the linguistic descriptions in another language.

5. The method of claim 1 wherein maintaining the linguistic descriptions in association with one another comprises pairing at least one of the linguistic descriptions in one language with at least one of the linguistic descriptions in another language, and further comprising, using the pairing to provide training data for training a machine translation system.

6. The method of claim 1 wherein maintaining the linguistic descriptions in association with one another comprises maintaining paraphrase data comprising descriptions in one language.

7. The method of claim 6 further comprising, using the paraphrase data to provide training data for training a machine paraphrasing system.

8. The method of claim 7 further comprising, evaluating quality of the machine paraphrasing system by measuring distinctiveness of an original sentence or phrase with a machine-generated paraphrased sentence or phrase.

9. The method of claim 8 wherein evaluating the quality further comprises, applying a metric to measure how well the machine-generated paraphrased sentence or phrase retains the original sentence's or phrase's meaning.

10. The method of claim 1 wherein presenting the stimulus comprises outputting video from an online video streaming site.

11. The method of claim 1 wherein collecting the linguistic description from each responding contributor comprises collecting the linguistic descriptions via a crowd-sourcing service.

12. The method of claim 1 further comprising, having the stimulus selected via a crowd-sourcing service.

13. The method of claim 1 further comprising, pre-processing the descriptions into training data for training a machine translation system or a machine paraphrasing system, or both for training a machine translation system and for training a machine paraphrasing system.

14. One or more computer-readable media having computer-executable instructions, which when executed perform steps of a process, comprising:
inputting input data corresponding to a set of words to a machine paraphrase system;
receiving output data from the machine paraphrase system corresponding to a paraphrase of the input data; and
evaluating quality of the machine paraphrase system, including obtaining a first score representing how well the output data retained the input data's original meaning, and a second score representing how distinct the output data is from the input data.

15. The computer-readable media of claim 14 wherein obtaining the second score comprises computing a dissimilarity score based on n-gram differences between the input data and the output data.

16. The computer-readable media of claim 14 having further computer-executable instructions comprising, selecting a paraphrase based upon the first and second scores, including choosing a paraphrase that is most distinct from the input data based on the second score and that retains the input data's original meaning within a range determined by the first score.

17. A system comprising, a source that provides a stimulus to contributors, a data collection mechanism configured to collect a linguistic description of that stimulus from each contributor, the data collection mechanism further configured to maintain translation data that associates linguistic descriptions of that stimulus that are in different languages with one another, and to maintain paraphrase data which, for at least one language, associates linguistic descriptions of that stimulus in that same language with one another.

18. The system of claim 17 further comprising, a training mechanism configured to access the translation data to train a machine translator.

19. The system of claim 17 further comprising, a training mechanism configured to access the paraphrase data to train a machine paraphrasing system.

20. The system of claim 19 further comprising a paraphrase quality measurement mechanism configured to perform a quality evaluation of the machine paraphrasing system, including via a distinctness metric of the paraphrase quality measurement mechanism.
